(19) United States
(12) Patent Application Publication
(10) Pub. No.: US 2007/0052898 A1
(43) Pub. Date: Mar. 8, 2007

(54) Multi-domain structure of wide-view-angle liquid crystal displays

(75) Inventors: Ming-Chang Yu, Taichung City (TW); Henta Kang, Taichung City (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/590,762

(22) Filed: Nov. 1, 2006

(30) Foreign Application Priority Data
Apr. 18, 2005 (TW) 094112177

(51) Int. Cl. G02F 1/1343

(52) U.S. Cl. 349/139

(57) ABSTRACT

The present invention is a multi-domain structure of wide-view-angle liquid crystal displays, which includes a first substrate having a pixel electrode. A slit is formed on the pixel electrode. There is at least one bump on the slit, which is used to form a multi-domain between every bump and the pixel electrode. Apertures on each bump can increase the aperture ratio of the liquid crystal display (LCD) so as to enhance the luminance of the LCD and to save the power consumption.

### FIELD OF THE INVENTION

The present invention relates to a wide-view-angle liquid crystal display, especially to a multi-domain structure of a wide-view-angle liquid crystal display (LCD) with multi-domain.

### BACKGROUND OF THE INVENTION

The view angle and brightness are important performance indexes of LCDs. Nowadays, the wide-view-angle technology of LCDs is mainly divided into two types. One is the extra type and the other is the build-in type such as In Plane Switching (IPS) mode and Multi-domain Vertical Alignment (MVA) mode.

U.S. Pat. No. 6,380,996 “Optical compensatory sheet and liquid crystal display” is the extra type which uses a compensation film (as shown in FIG. 1) with birefrigence (Δn<0) to compensate the phase difference caused by the TN LC cell (Δn>0) in order to achieve the goal of wide view angle. Although the extra type can effectively improve the view angle through a precise compensation film, the compensation film is fixed after all which cannot compensate any angle or any gray-level. Therefore, the intrinsic gray-level inverse phenomenon of the TN mode LCDs still exists.

U.S. Pat. No. 559828 “Liquid crystal display device” is the build-in type which is an IPS mode. It arranges strip-shaped positive/negative electrodes on a substrate alternately (as shown in FIG. 2). When a voltage is applied to the electrode, the LC molecules that are originally parallel to the electrode will rotate to be perpendicular to the electrode whereas the long axes of the LC molecules are still parallel to the substrate. The LC molecules can be rotated to the desired angle by controlling the amplitude of the voltage. The transmission ratio of the polarized light can be tuned so as to show different gray-levels by cooperating with a polarizer. The arrangement of the LC molecules is not TN type but the long axes of the LC molecules are always parallel to the substrate.

A plane electric field can be built up to drive the LC molecules moving transversally because the electrodes of IPS mode are at the same plane, unlike the electrodes of other LC modes are at the top and down two faces of the substrate. It is no problem for LC molecules that close to the electrode to rapidly twist 90 degrees because LC molecules close to the electrode obtain more power after a voltage is applied to the electrode. But upper layer LC molecules far from the electrode cannot obtain the same power and move slower. Only increasing the driving voltage can let LC molecules that are far from the electrode also obtain enough power. Accordingly, the driving voltage of the IPS mode is higher. In general, it needs 15 volts. Besides, the IPS mode needs more backlight tubes because electrodes at the same plane will lower the aperture ratio and the transmission ratio.

The most mature wide-view-angle technology for application is the MVA mode that needs to grow protrusions or so called bumps on the substrate so as to pretilt the LC molecules. Multi-domains are formed by way of the geometric arrangement of the protrusions (bumps) so as to achieve the requirement of wide view angle.

U.S. Pat. No. 6,661,488 “Vertically-aligned (VA) liquid crystal display device” proposed a technology that makes the LC to produce a pretilt angle by protrusions (as shown in FIG. 3). The larger the interior angle of the protrusion, the smaller tilt angle of the long axis of the molecule.

Please refer to FIG. 4 which is a dual-domain MVA mode LC. The long axis of the molecule is perpendicular to the panel when the voltage is off. Lights cannot pass through the up and down two polarizers only when the LC molecules close to the bump electrode tilt slightly. After the voltage is on, the LC molecules close to the bump will drive other LC molecular to rotate to be perpendicular to the bump surface, i.e. the long axis of the molecule inclines to the panel. At this time, the transmission ratio increases such that tuning lights is actualized. The neighboring LC molecules are just symmetrical and long axes point to different directions in the dual-domain mode. The MVA mode uses the characteristic that long axes point to different directions to realize the optical compensation.

The real view effect is shown in FIG. 5. A middle gray-level can be seen at B place. Both high gray-level and low gray-level can simultaneously be seen at A and C places. A middle gray level can be gained after color mixing. This approach can improve the view angle direction of LCDs and lower the response time of the LC molecules.

R.O.C. Patent Publication No. 548475 “The structure of the multi-domain vertical alignment LCDs and the manufacturing method for their bump structure” is a MVA mode wide-view-angle technology. It uses the self-align exposure method to form interlaced bumps around the pixel electrodes (as shown in FIG. 6). The bump makes the LC molecules to form a pretilt angle. Applying voltage can control the direction of the LC molecules so as to form the multi-domain vertical alignment for the LC molecules.

The brightness of a display relates to the aperture ratio significantly. Main factors that affect the aperture ratio are structures of TFTs, CSTs, and bumps. To increase the brightness, except trying to increase the aperture ratio of a LCD, utilizing surrounding lights to be the display light source also can achieve the effects of saving electricity and increasing brightness such as a semi-transmissive LCD that has both merits of a transmissive and a reflective type LCDs. But refer to the semi-transmissive effect, U.S. Pat. No. 6,195,140 “Liquid crystal display in which at least one pixel includes both a transmissive region and reflective region” proposed a dual cell gap technology that there are different thickness of LC layer on the reflective area and the transmissive area in a sub-pixel. When dR=dT/2 the reflective area and the transmissive area have the same phase difference (as shown in FIG. 7).

Besides, a reflective type and transmissive type LCD is applied to single cell gap LC devices. The method is that adding a micro-reflective film at the surface of the down plate (as shown in FIG. 8). Lights can pass through the micro-reflective film from the bottom and reflect due to the micro-reflective film when input from the top.

### SUMMARY OF THE INVENTION

Consequently, for solving the abovementioned problems, the main purpose of the present invention is to form the bumps with multi-domain effect having apertures and being discontinuous so as to increase the aperture ratio of the LCD.

The second purpose of the present invention is to form the first substrate having the reflection effect, which installs a capacitor under the bump, reflects surrounding lights by way of the capacitors so as to form a wide-view-angle LCD with the reflection effect.

The present invention is a multi-domain structure of wide-view-angle LCDs, which includes a first substrate, a pixel electrode and at least one bump. The pixel electrode is provided on the first substrate. The pixel electrode has a slit. The bump is provided on the slit of the pixel electrode. The bump has apertures and presents a discontinuous shape. Besides, the bump can be replaced by a plurality of sub-bumps provided in the slit of the pixel electrode and spaced apart from each other. The area between the bump (or the sub-bumps) and the pixel electrode forms the multi-domain.

The present invention forms the bump with LC multi-domain effect having apertures and being discontinuous such that the aperture ratio of a LCD can be increased. Besides, the present invention also can install a reflection layer, such as a capacitor, under the bump. Reflecting surrounding lights by way of the capacitor can form a wide-view-angle LCD with the reflective effect.

### BRIEF DESCRIPTION FOR THE DRAWINGS

FIG. 1 is the schematic diagram for an extra compensation film.

FIG. 2 is the schematic diagram for a build-in IPS mode liquid crystal.

FIG. 3 is the schematic diagram for a build-in MVA mode liquid crystal.

FIG. 4 is the schematic diagram for a build-in double-domain MVA mode liquid crystal.

FIG. 5 is the schematic diagram of a real visual effect for a build-in MVA mode liquid crystal.

FIG. 6 is the schematic diagram for the bump location of a build-in MVA mode.

FIG. 7 is the schematic diagram for devices of a double cell gap.

FIG. 8 is the schematic diagram for devices of a single cell gap.

FIG. 9A is the vertical schematic diagram for the multi-domain structure of the first embodiment example of the present invention.

FIG. 9B is the schematic diagram for 9B-9B cross-section structure of FIG. 9A of the present invention.

FIG. 10 is the schematic diagram for the cross-section structure of the second embodiment example.

FIG. 11 is the schematic diagram for the cross-section structure of the third embodiment example.

FIG. 12 is the schematic diagram for the cross-section structure of the fourth embodiment example.

FIG. 13A is the vertical schematic diagram for the multi-domain structure of the fifth embodiment example of the present invention.

FIG. 13B is the schematic diagram for 13B-13B cross-section structure of FIG. 13A of the present invention.

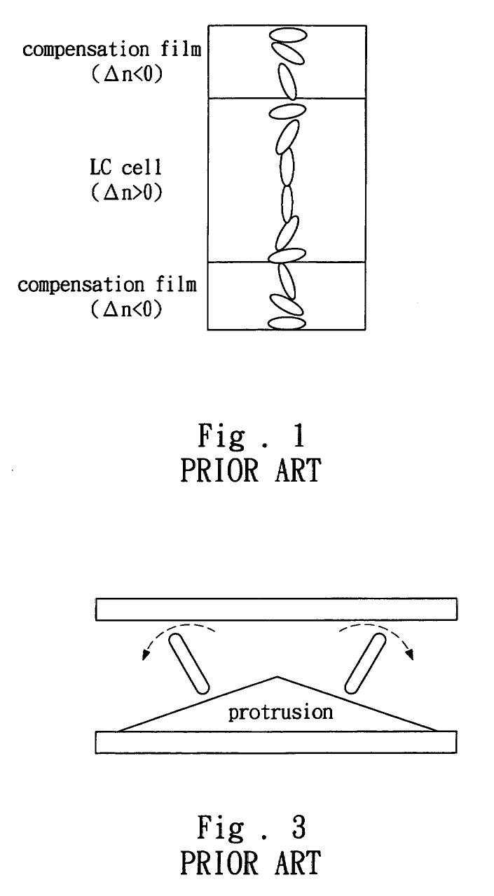

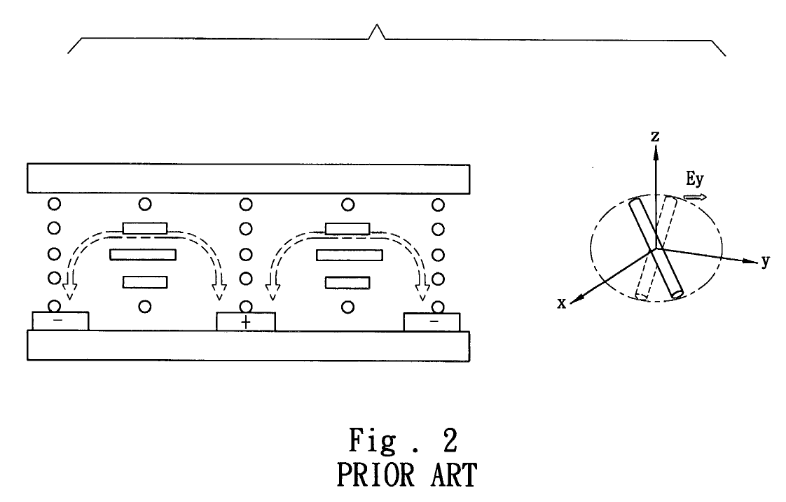

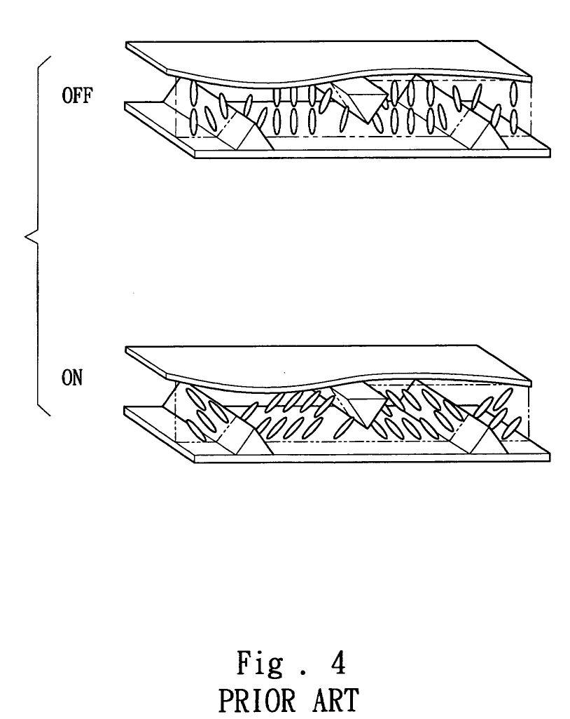

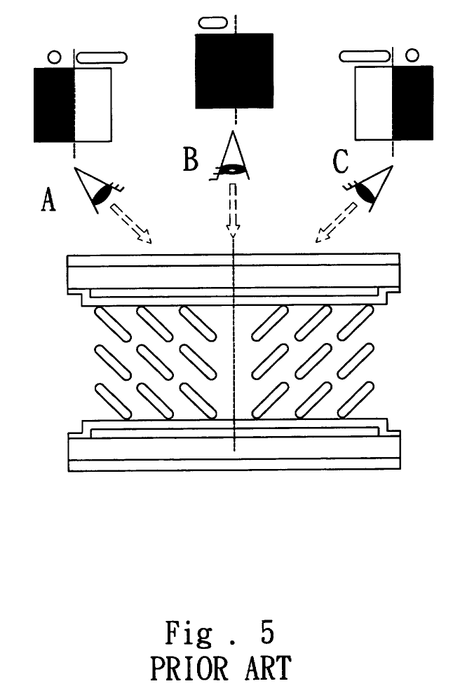

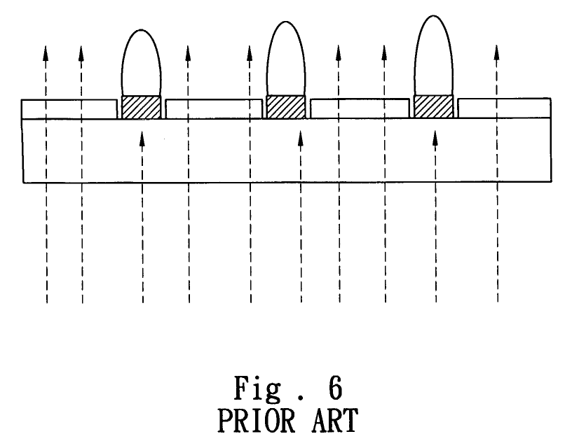

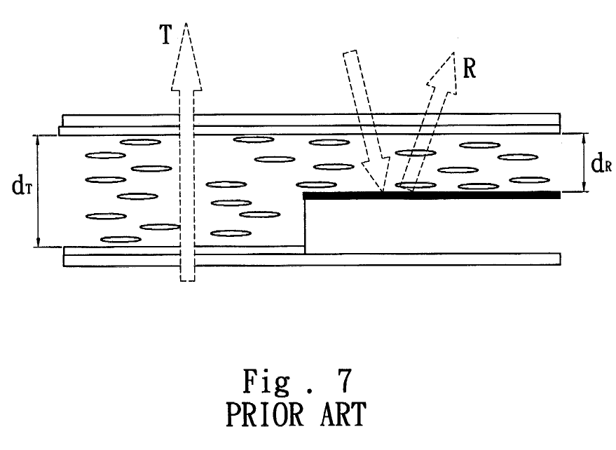

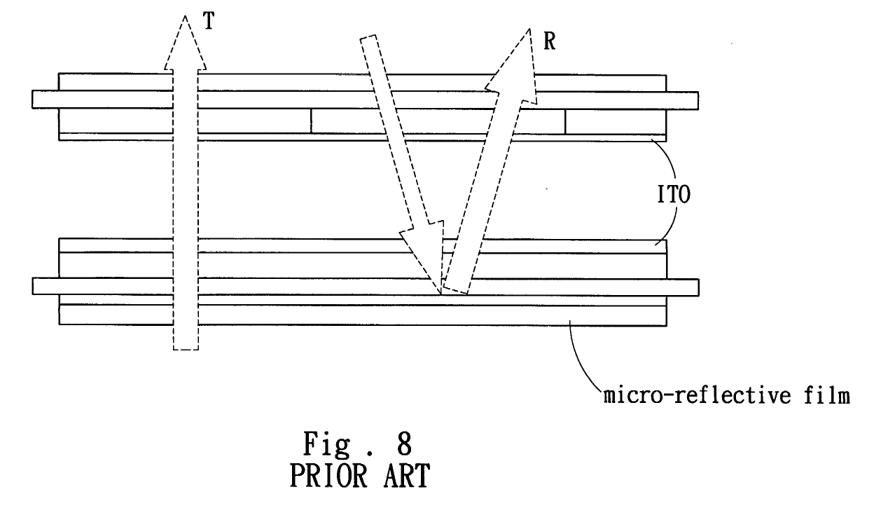

### DETAILED DESCRIPTION OF THE PREFERRED EMBODIMENTS

The present invention will become more fully understand from the detailed description given hereinbelow and the accompanying drawings which are given by way of illustration only, and thus are not limitative of the present invention.

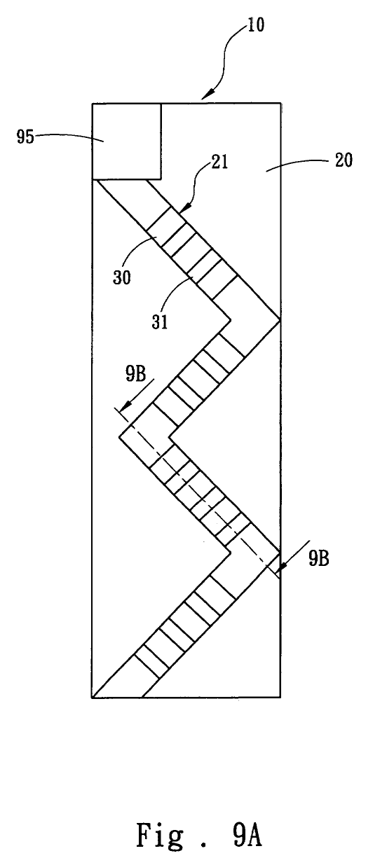

Please refer to FIGS. 9A and 9B, which illustrate the first embodiment example of the present invention. It includes a first substrate 10, a pixel electrode 20, and at least one bump 30. The pixel electrode 20 separated by a protection layer 80 is provided on the first substrate 10. The pixel electrode 20 has a slit 21. The bump 30 is provided on the slit 21 of the pixel electrode 20. The bump 30 has apertures 31 and presents a discontinuous shape, such that the area between the bump 30 and the pixel electrode 20 forms the multi-domain.

In the first embodiment example, a first metal layer 40 is provided on the first substrate 10. An insulation layer 70 is provided on the first metal layer 40, and a second metal layer 50 is provided on the insulation layer 70. The insulation layer 70 is pinched between the first metal layer 40 and the second metal layer 50, and thus forms a capacitor. The capacitor is provided under the slit 21, and the capacitor can be the parallel capacitor of the TFT 95. The first metal layer 40 and the second metal layer 50 can be high reflective and low resistant metal materials such as Al, Cr, Al—Nd alloy, or Ag, etc. Moreover, the first embodiment example even can include a polarization layer 60. The polarization layer 60 covers the first substrate 10 and is provided above the pixel electrode 20 and the bump 30.

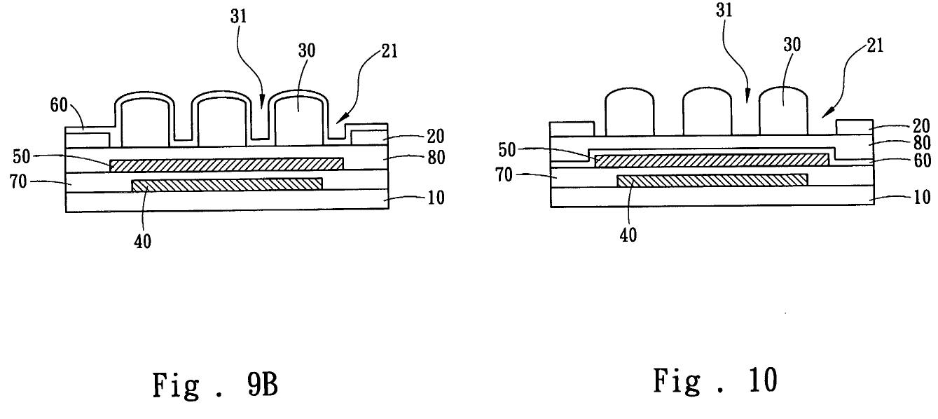

Please refer to FIG. 10, which illustrates the second embodiment example of the present invention. The second embodiment example includes a first substrate 10, a pixel electrode 20, a slit 21, at least one bump 30, apertures 31, a protection layer 80, a polarization layer 60, a first metal layer 40, and a second metal layer 50. An insulation layer 70 is pinched between the first metal layer 40 and the second metal layer 50, and thus forms a capacitor that can be the parallel capacitor of the TFT 95. The arrangement for each layer is approximately the same as the first embodiment example. The different is that the polarization layer 60 covers the first substrate 10 and is provided above the capacitor (the second metal layer 50).

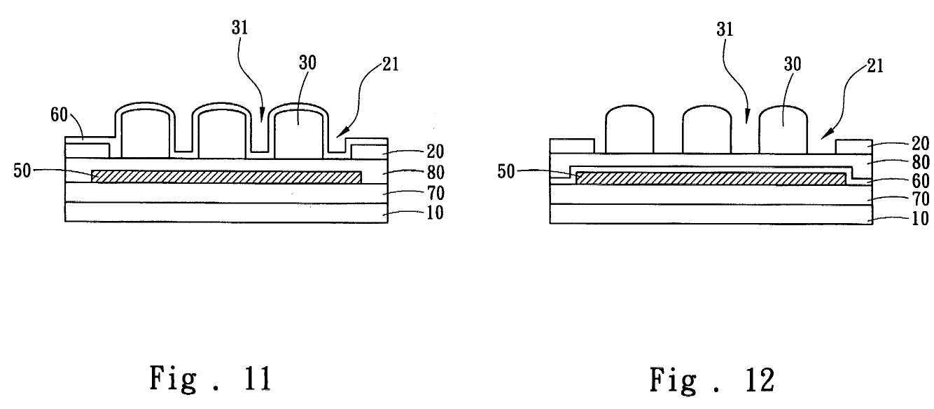

Please further refer to FIG. 11, which illustrates the third embodiment example of the present invention. The vertical view of the third embodiment example is the same as the first embodiment example (as shown in FIG. 9A), which includes a first substrate 10, a pixel electrode 20, at least one bump 30, and an insulation layer 70. Being separated by a protection layer 80 the pixel electrode 20 is provided on the first substrate 10. The pixel electrode 20 has a slit 21. The bump 30 is provided on the slit 21 of the pixel electrode 20. The bump 30 has apertures 31 and presents a discontinuous shape such that the area between the bump 30 and the pixel electrode 20 forms the multi-domain.

In the third embodiment example, the second metal layer 50 is provided on the first substrate 10, the protection layer 80 is provided on the second metal layer 50. The cover area of the second metal layer 50 is larger than that of the slit 21 and has an overlap with the pixel electrode 20. The pixel electrode 20 and the second metal layer 50 are separated by the protection layer 80 and form a capacitor. The capacitor can be the parallel capacitor of the TFT 95. In which the second metal layer 50 can be a high reflective and low resistant metal material such as Al, Cr, Al—Nd alloy, or Ag, etc. Moreover, the third embodiment example even includes a polarization layer 60. The polarization layer 60 covers the first substrate 10 and is provided above the pixel electrode 20 and the bump 30.

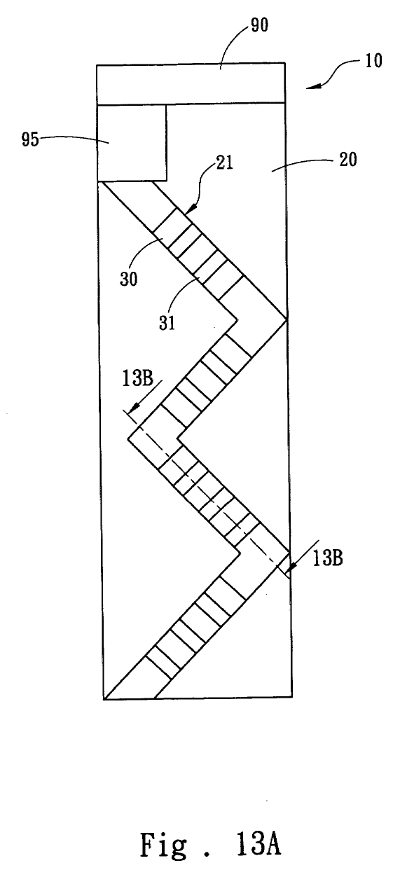

Please refer to FIG. 12, which illustrates the fourth embodiment example of the present invention. The fourth embodiment example includes a first substrate 10, a pixel electrode 20, a slit 21, at least one bump 30, apertures 31, an insulation layer 70, a protection layer 80, a polarization layer 60, and a second metal layer 50. The pixel electrode 20 and the second metal layer 50 are separated by the protection layer 80 and form a capacitor that can be the parallel capacitor of the TFT 95. The arrangement for each layer is approximately the same as the third embodiment example. The different is that the polarization layer 60 covers the first substrate 10 and is provided above the second metal layer 50.

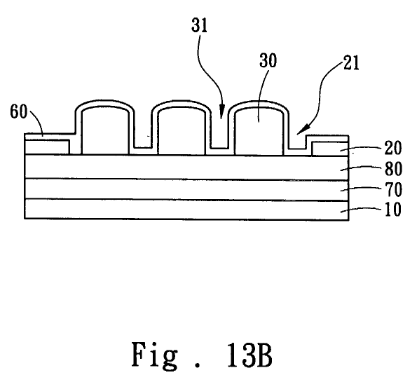

Please refer to FIGS. 13A and 13B, which illustrate the fifth embodiment example of the present invention. It includes a first substrate 10, a pixel electrode 20, and at least one bump 30. Being separated by an insulation layer 70 and a protection layer 80, the pixel electrode 20 is provided on the first substrate 10. The pixel electrode 20 has a slit 21. The bump 30 is provided on the slit 21 of the pixel electrode 20. The bump 30 has apertures 31 and presents a discontinuous shape. A capacitor 90 is provided on the first substrate 10; the capacitor 90 is used as the parallel capacitor of the TFT 95. Moreover, the fifth embodiment example even includes a polarization layer 60. The polarization layer 60 covers the first substrate 10 and is provided above the pixel electrode 20 and the bump 30. Besides, in the fifth embodiment example, a metal reflective layer (not shown in the figures) can be further provided on the first substrate 10, and the metal reflective layer is provided under the slit 21.

The five embodiment examples of the present invention further cooperate with a second substrate (not shown in the figures), a polarization film (not shown in the figures) that is orthogonal to the polarization axis of the polarization film 60, and install a common electrode on the second substrate (not shown in the figures), install rubbing films (not shown in the figures) on the first substrate and the second substrate, and fill LC molecules then a basic structure for a wide-view-angle LCD is constructed.

Therefore, each embodiment example of the present invention can utilizes apertures 31 owned by the discontinuous-shape bump 30 to increase the effective display area so as to increase the aperture ratio. Moreover, displays can have the reflective effect by way of the reflective ability owned by the material of the capacitor or the metal reflective layer.

The width of the aperture 31 of the bump 30 described in each embodiment example of the present invention is related to the aperture ratio of an LCD. Increasing the width of the aperture 31 can enhance the aperture ratio of a LCD whereas can worsen the multi-domain effect. Accordingly, the best width of the aperture 31 of the bump 30 in the present invention is between 0.5 μm˜30 μm. Besides, the bump 30 is made of a transparent material that can increase the utility efficiency.

As described above, the bump 30 can be replaced by a plurality of sub-bumps provided in the slit 21 of the pixel electrode 20 and spaced apart from each other. Since the sub-bumps as a whole have the same dimension as the bump 30, the sub-bumps can reach the same function. The present invention makes the bump 30 with the LC multi-domain effect to be a discontinuous shape so as to increase the aperture ratio of a LCD. Moreover, the present invention can form the first substrate 10 having the reflection effect so as to form a wide-view-angle LCD. Consequently, the present invention can increase the utility efficiency of the light source so as to increase the luminance and save the power.

However, what described above should simply be deemed better examples of the present invention, not as a limitation to its range of implementation. All proportional variations or modifications based on the range claimed in this patent are covered by the present invention patent.

What is claimed is:

1. A multi-domain structure of wide-view-angle liquid crystal displays, comprising:
a first substrate;
a pixel electrode provided on the first substrate and having a slit therein; and
a bump provided in the slit and having a plurality of apertures to form a discontinuous shape.

2. The multi-domain structure as claimed in claim 1, wherein a first metal layer is provided on the first substrate, an insulation layer is provided on the first metal layer, a second metal layer is provided on the insulation layer, the insulation layer is pinched between the first metal layer and the second metal layer and thus forms a capacitor, and the capacitor is provided under the slit.

3. The multi-domain structure as claimed in claim 2, wherein the first metal layer and the second metal layer are high reflective as well as low resistant metal materials, and the material for the first metal layer and the second metal layer is selected from the group consisting of Al, Cr, Al—Nd alloy, and Ag.

4. The multi-domain structure as claimed in claim 2, further including a polarization layer, the polarization layer covering the first substrate and being provided above the pixel electrode and the bump.

5. The multi-domain structure as claimed in claim 2, further comprising a polarization layer, the polarization layer covering the first substrate and being provided above the capacitor.

6. The multi-domain structure as claimed in claim 1, wherein a second metal layer is provided on the first substrate, a protection layer is provided on the second metal layer, the cover area of the second metal layer is larger than that of the slit and has an overlap with the pixel electrode, and the pixel electrode and the second metal layer are separated by the protection layer and form a capacitor.

7. The multi-domain structure as claimed in claim 6, wherein the second metal layer is a high reflective as well as low resistant metal material, and the material of the second metal layer is selected from the group consisting of Al, Cr, Al—Nd alloy, and Ag.

8. The multi-domain structure as claimed in claim 6, further comprising a polarization layer, the polarization layer covering the first substrate and being provided above the pixel electrode and the bump.

9. The multi-domain structure as claimed in claim 6, further comprising a polarization layer, the polarization layer covering the first substrate and being provided above the second metal layer.

10. The multi-domain structure as claimed in claim 1, further comprising a polarization layer, the polarization layer covering the first substrate and being provided above the pixel electrode and the bump.

11. The multi-domain structure as claimed in claim 1, wherein the width of the aperture of the bump is between 0.5 μm˜30 μm.

12. The multi-domain structure as claimed in claim 1, wherein the bump is made of a transparent material.

13. A multi-domain structure of wide-view-angle liquid crystal displays, comprising:
a first substrate;
a pixel electrode provided on the first substrate and having a slit therein; and
a plurality of sub-bumps provided in the slit of the pixel electrode and spaced apart from each other.

14. The multi-domain structure as claimed in claim 13, wherein a first metal layer is provided on the first substrate, an insulation layer is provided on the first metal layer, a second metal layer is provided on the insulation layer, the insulation layer is pinched between the first metal layer and the second metal layer and thus forms a capacitor, and the capacitor is provided under the slit.

15. The multi-domain structure as claimed in claim 14, wherein the first metal layer and the second metal layer are high reflective as well as low resistant metal materials, and the material for the first metal layer and the second metal layer is selected from the group consisting of Al, Cr, Al—Nd alloy, and Ag.

16. The multi-domain structure as claimed in claim 14, further including a polarization layer, the polarization layer covering the first substrate and being provided above the pixel electrode and the sub-bumps.

17. The multi-domain structure as claimed in claim 14, further comprising a polarization layer, the polarization layer covering the first substrate and being provided above the capacitor.

18. The multi-domain structure as claimed in claim 13, wherein a second metal layer is provided on the first substrate, a protection layer is provided on the second metal layer, the cover area of the second metal layer is larger than that of the slit and has an overlap with the pixel electrode, and the pixel electrode and the second metal layer are separated by the protection layer and form a capacitor.

19. The multi-domain structure as claimed in claim 18, wherein the second metal layer is a high reflective as well as low resistant metal material, and the material of the second metal layer is selected from the group consisting of Al, Cr, Al—Nd alloy, and Ag.

20. The multi-domain structure as claimed in claim 18, further comprising a polarization layer, the polarization layer covering the first substrate and being provided above the pixel electrode and the sub-bumps.

21. The multi-domain structure as claimed in claim 18, further comprising a polarization layer, the polarization layer covering the first substrate and being provided above the second metal layer.

22. The multi-domain structure as claimed in claim 13, further comprising a polarization layer, the polarization layer covering the first substrate and being provided above the pixel electrode and the sub-bumps.

23. The multi-domain structure as claimed in claim 13, wherein the width of the space between the sub-bumps is between 0.5 μm˜30 μm.
